(19) United States
(12) Patent Application Publication
(10) Pub. No.: US 2011/0150506 A1
(43) Pub. Date: Jun. 23, 2011

(54) OPTICAL RECEIVER AND RECEIVING METHOD

(75) Inventors: Takahito TANIMURA, Kawasaki (JP); Tomoo Takahara, Kawasaki (JP); Takeshi Hoshida, Kawasaki (JP)

(73) Assignee: FUJITSU LIMITED, Kawasaki (JP)

(21) Appl. No.: 12/958,828

(22) Filed: Dec. 2, 2010

(30) Foreign Application Priority Data
Dec. 22, 2009 (JP) 2009-290793

(51) Int. Cl. H04B 10/06

(52) U.S. Cl. 398/208; 398/202

(57) ABSTRACT

An optical receiver includes an optical front-end, a digital converter, a frequency-characteristic-difference reducing unit and an identifying unit. The optical front-end splits an input signal light into signal light components on a basis of local light and converts the split signal light components into electrical signals. The digital converter converts the electrical signals, converted by the optical front end, into digital signals. The frequency-characteristic-difference reducing unit reduces a frequency-characteristic difference between the digital signals converted by the digital converter. The identifying unit identifies each of the digital signals whose frequency-characteristic difference is reduced by the frequency-characteristic-difference reducing unit.

### CROSS-REFERENCE TO RELATED APPLICATIONS

This application is based upon and claims the benefit of priority of the prior Japanese Patent Application No. 2009-290793, filed on Dec. 22, 2009, the entire contents of which are incorporated herein by reference.

### BACKGROUND

1. Field

Various embodiments described herein relate to an optical receiver for receiving signal light and to a receiving method.

2. Description of the Related Art

In recent years, for optical receivers for receiving signal light, technical research and development on digital coherent reception have been carried out (e.g., refer to Alcatel-Lucent, Bell-Labs France, Centre de Villarcuaux, Route de Villejust, “Coherent detection associated with digital signal processing for fiber optics communication”, December 2008 below). In digital coherent reception, an analog-to-digital converter (ADC) is used to convert physical characteristics, such as the intensity and the phase of signal light, into digital signals, which are then subjected to computation to allow identification of the signal light.

In the digital coherent reception, both of information of the amplitude and information of the phase of an optical-electric field are obtained as electrical signals, unlike a direct detection system typically used in the past. Thus, the digital coherent reception has an advantage in that a signal distortion can be compensated for by an electrical equalization filter. The digital coherent reception also allows the sensitivity and noise-tolerance of a receiver to be increased through coherent reception and digital signal processing.

Examples of a signal-light modulation system employing the digital coherent reception include Differential Quadrature Phase Shift Keying (DQPSK) and Multi Phase Shift Keying (MPSK) such as Quadrature Amplitude Modulation (QAM).

However, in the above-noted related art, an optical front end for splitting a signal light into light components of individual channels and photoelectrically converting the light components into electrical signals produces a frequency-characteristic difference between the signals of the individual channels. Thus, there is a problem in that the signals cannot be received with high accuracy. In particular, in conjunction with the increasing transmission speed of signal light in recent years, a reception-accuracy reduction due to the frequency-characteristic difference has become considerable.

The frequency-characteristic difference between the signals of the individual channels is caused by, for example, variations in manufacturing of an analog section in the optical front end. In order to deal with the variations, a high-performance optical front end may be used to increase the bandwidth to thereby enhance the reception accuracy. Such an approach, however, poses a problem in that the cost of the optical receiver increases.

### SUMMARY

An optical receiver includes an optical front-end, a digital converter, a frequency-characteristic-difference reducing unit and an identifying unit. The optical front-end splits an input signal light into signal light components based on a local light and converts the split signal light components into electrical signals. The digital converter converts the electrical signals, converted by the optical front end, into digital signals. The frequency-characteristic-difference reducing unit reduces a frequency-characteristic difference between the digital signals converted by the digital converter. The identifying unit identifies each of the digital signals whose frequency-characteristic difference is reduced by the frequency-characteristic-difference reducing unit.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an optical receiver according to an embodiment;

FIG. 2 is a block diagram illustrating a specific example of an optical front end illustrated in FIG. 1;

FIG. 3 is a block diagram illustrating a specific example of a frequency-characteristic-difference compensating unit illustrated in FIG. 1;

FIG. 4 is a block diagram illustrating a modification of an optical receiver illustrated in

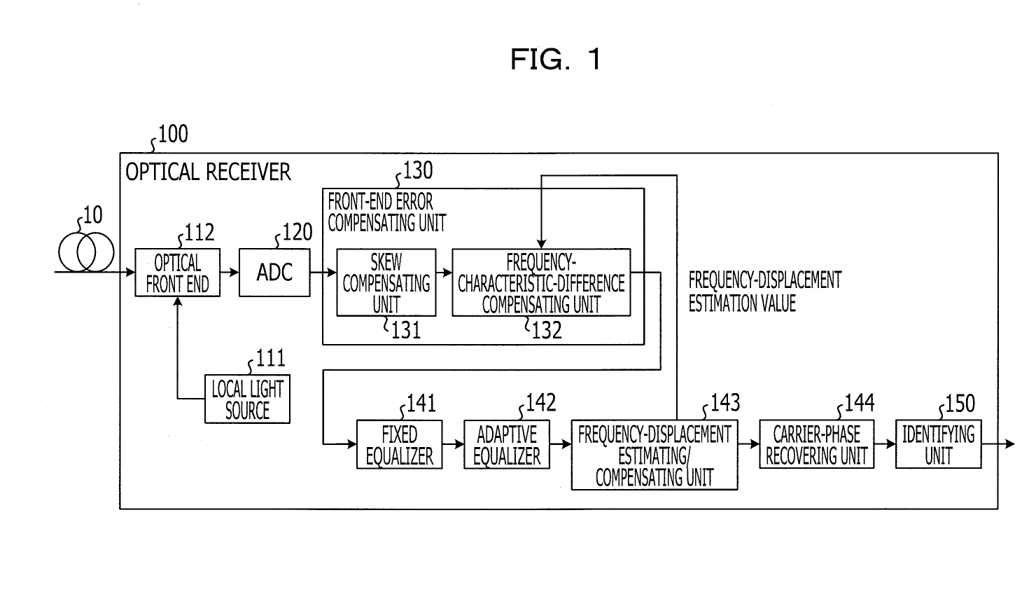

FIG. 1;

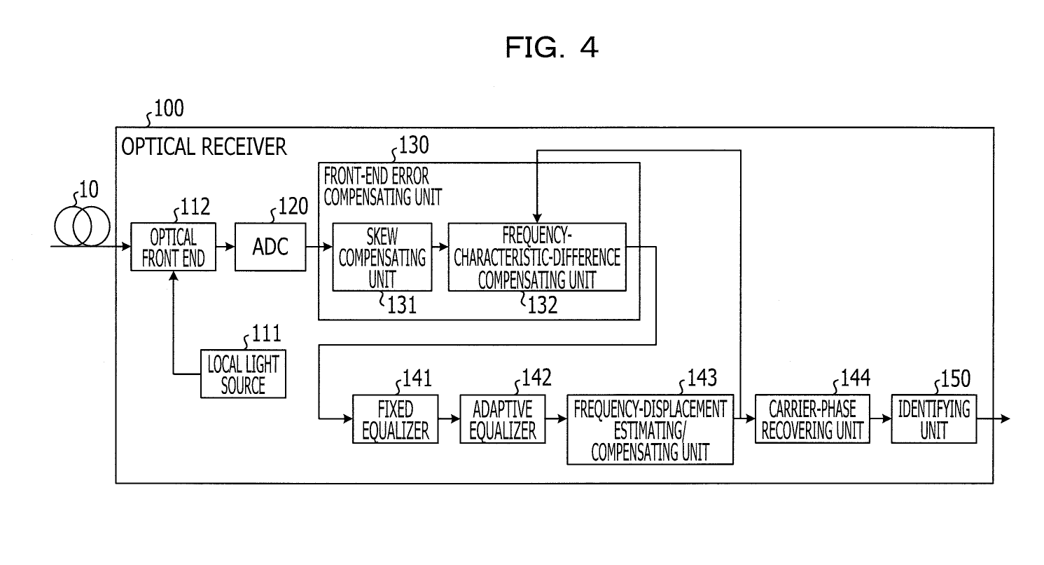

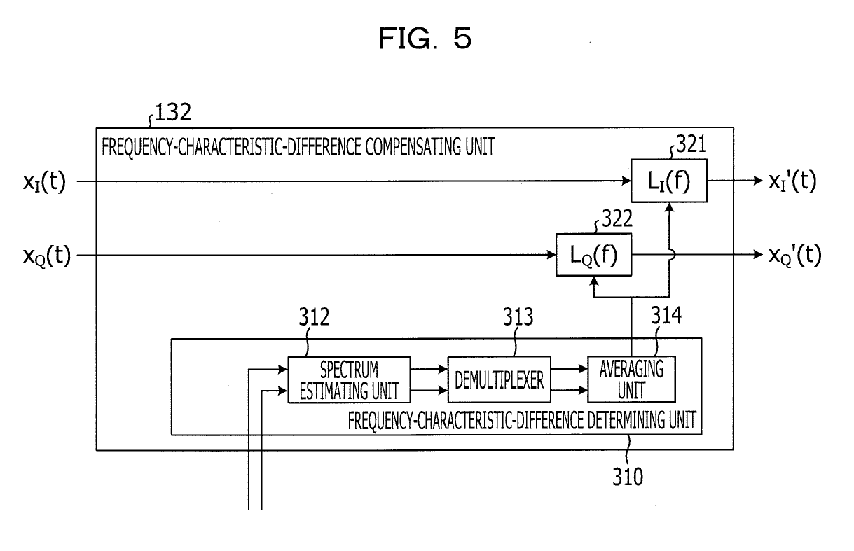

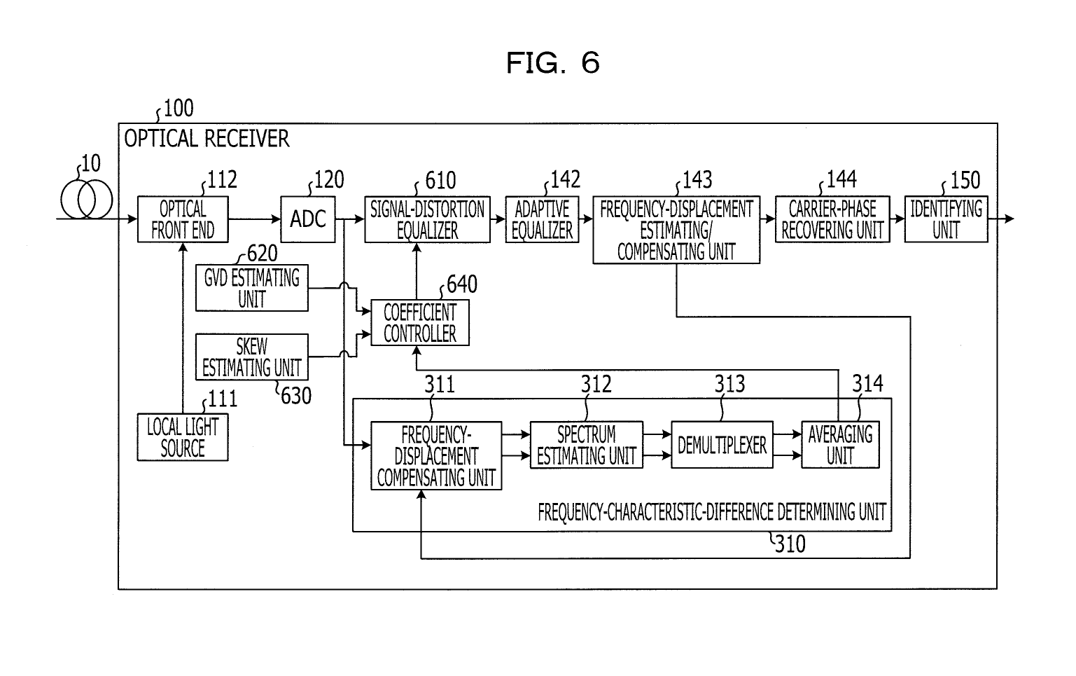

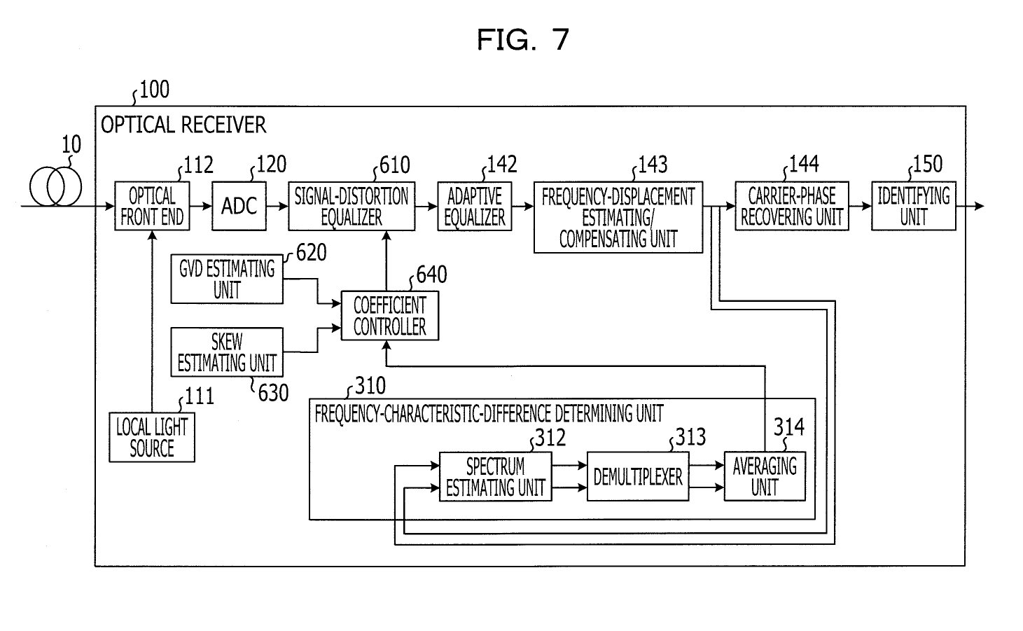

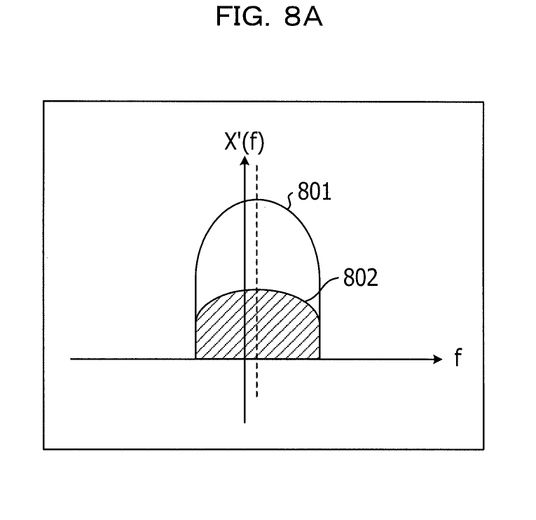

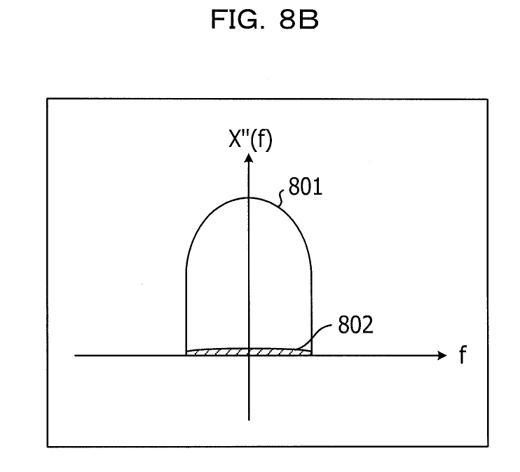

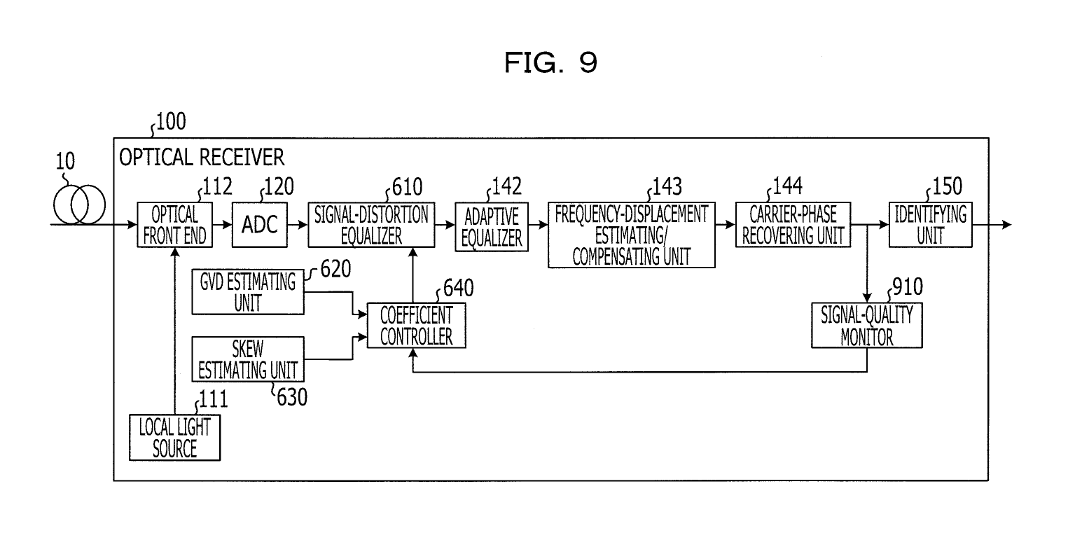

FIG. 5 is a block diagram illustrating a frequency-characteristic-difference compensating unit illustrated in FIG. 4;

FIG. 6 is a block diagram of an optical receiver according to an embodiment;

FIG. 7 is a block diagram illustrating a modification of an optical receiver illustrated in FIG. 6;

FIG. 8A is a graph illustrating a signal output from an optical front end;

FIG. 8B is a graph illustrating a signal output from a frequency-characteristic-difference compensating unit; and

FIG. 9 is a block diagram of an optical receiver according to an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

An optical receiver and a receiving method according to preferred embodiments will be described below in detail with reference to the accompanying drawings. Through use of signals resulting from compensation for a frequency displacement between a signal light and local light, the disclosed optical receiver and receiving method accurately determine and compensate for a frequency-characteristic difference between signals of individual channels to receive the signals with high accuracy.

FIG. 1 is a block diagram of an optical receiver according to an embodiment. As illustrated in FIG. 1, an optical receiver 100 according to an embodiment includes a local light source 111, an optical front end 112, an analog-to-digital converter (ADC) 120, a front-end error compensating unit 130, a fixed equalizer 141, an adaptive equalizer 142, a frequency-displacement estimating/compensating unit 143, a carrier-phase recovering unit 144, and an identifying unit 150. The optical receiver 100 receives signal light transmitted through a transmission path 10. The signal light received by the optical receiver 100 includes multiple channels (e.g., in-phase (I) and quadrature-phase (Q) channels).

The local light source 111 generates local light and outputs the local light to the optical front end 112. The signal light from the transmission path 10 and the local light from the local light source 111 are input to the optical front end 112. On the basis of the local light, the optical front end 112 splits the input signal light into signal light components of individual channels. The optical front end 112 photoelectrically converts the signal light components, split for the individual channels, into electrical signals of the individual channels and outputs the signals of the individual channels to the ADC 120 (the signals of the individual channels may be hereinafter referred to as “channel signals”).

The ADC 120 (which serves as a digital converter) converts the channel signals, output from the optical front end 112, into digital channel signals. The ADC 120 then outputs the digital channel signals to the front-end error compensating unit 130.

The front-end error compensating unit 130 compensates for inter-channel error of the digital channel signals output from the ADC 120, the inter-channel error being caused by the optical front end 112. The front-end error compensating unit 130 includes a skew compensating unit 131 and a frequency-characteristic-difference compensating unit 132. The skew compensating unit 131 compensates for a skew between the channel signals output from the ADC 120. The skew compensating unit 131 outputs skew-compensated signals to the frequency-characteristic-difference compensating unit 132.

The frequency-characteristic-difference compensating unit 132 serves as a frequency-characteristic-difference reducing unit for compensating for a frequency-characteristic difference between the channel signals output from the skew compensating unit 131. More specifically, the frequency-characteristic-difference compensating unit 132 compensates for a frequency-characteristic difference between the channel signals, on the basis of a frequency-displacement estimation value output from the frequency-displacement estimating/compensating unit 143. The frequency-characteristic-difference compensating unit 132 is not limited to a unit for fully compensating for the frequency-characteristic difference, but also may be a unit for reducing the frequency-characteristic difference. The frequency-characteristic-difference compensating unit 132 outputs, to the fixed equalizer 141, the signals whose frequency-characteristic difference is compensated.

The fixed equalizer 141 serves as a dispersion reducing unit that compensates for a dispersion of the channel signals, output from the front-end error compensating unit 130, by using a fixed filter coefficient and that outputs the dispersion-compensated signals to the adaptive equalizer 142. The adaptive equalizer 142 serves as a dispersion reducing unit that compensates for a dispersion of the channel signals, output from the fixed equalizer 141, by using a variable filter coefficient and that outputs the dispersion-compensated signals to the frequency-displacement estimating/compensating unit 143. Each of the fixed equalizer 141 and the adaptive equalizer 142 is not limited to an equalizer for fully compensating for the dispersion, but also may be an equalizer for reducing the amount of dispersion.

The frequency-displacement estimating/compensating unit 143 serves as a frequency-displacement reducing unit that estimates a frequency displacement between the channel signals output from the adaptive equalizer 142 and that compensates for the frequency displacement between the signals on the basis of a frequency-displacement estimation value. The frequency displacement estimated and compensated for by the frequency-displacement estimating/compensating unit 143 is a frequency displacement between the signal light input to the optical front end 112 and the local light output from the local light source 111. The frequency-displacement estimating/compensating unit 143 is not limited to a unit for fully compensating for the frequency displacement, but also may be a unit for reducing the amount of frequency displacement. The frequency-displacement estimating/compensating unit 143 outputs the frequency-displacement-compensated signals to the carrier-phase recovering unit 144. The frequency-displacement estimating/compensating unit 143 outputs the frequency-displacement estimation value to the front-end error compensating unit 130.

The carrier-phase recovering unit 144 performs carrier-phase recovery processing on the channel signals output from the frequency-displacement estimating/compensating unit 143 and outputs the resulting signals to the identifying unit 150. The identifying unit 150 performs processing for identifying each of the signals output from the carrier-phase recovering unit 144 and outputs a result of the identification to a subsequent stage.

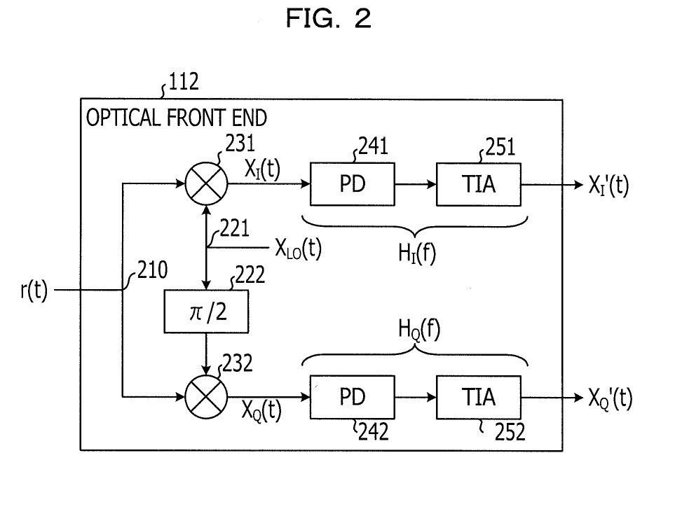

FIG. 2 is a block diagram illustrating a specific example of the optical front end illustrated in FIG. 1. As illustrated in FIG. 2, the optical front end 112 includes dividers 210 and 221, a phase shifter 222, couplers 231 and 232, photo detectors (PDs) 241 and 242, and trans-impedance amplifiers (TIAs) 251 and 252. In FIG. 2, r(t) indicates the signal light input to the optical front end 112, t indicates time, and XLO(t) indicates the local light input to the optical front end 112. The local light XLO(t) is expressed by cos(2πfct), where fc indicates a frequency of the local light.

The divider 210 divides the signal light r(t) input to the optical front end 112 and outputs the resulting light components to the couplers 231 and 232. The divider 221 divides the local light XLO(t) input to the optical front end 112 and outputs the resulting light components to the coupler 231 and the phase shifter 222. The phase shifter 222 shifts the phase of the local light components, output from the divider 221, by π/2 and outputs the phase-shifted local light XLO(t) to the coupler 232.

The coupler 231 multiplexes the signal light r(t) output from the divider 210 and the local light XLO(t) output from the divider 221. Consequently, it is possible to extract an I-channel signal XI(t) included in the signal light. The coupler 231 outputs the extracted signal XI(t) to the photo detector 241. The coupler 232 multiplexes the signal light r(t) output from the divider 210 and the local light XLO(t) output from the phase shifter 222. Consequently, it is possible to extract a Q-channel signal XQ(t) included in the signal light. The coupler 232 outputs the extracted signal XQ(t) to the photo detector 242.

The photo detector 241 converts the I-channel signal XI(t), output from the coupler 231, into an electrical signal and outputs the electrical signal to the TIA 251. The photo detector 242 converts the Q-channel signal XQ(t), output from the coupler 232, into an electrical signal and outputs the electrical signal to the TIA 252.

The TIA 251 amplifies the I-channel signal output from the photo detector 241 and outputs the resulting signal to the ADC 120 (see FIG. 1). The I-channel signal output from the TIA 251 is denoted by a signal XI′(t). The TIA 252 amplifies the Q-channel signal output from the photo detector 242 and outputs the resulting signal to the ADC 120 (see FIG. 1). The Q-channel signal output from the TIA 252 is denoted by a signal XQ′(t).

A frequency characteristic HI(f) is a frequency characteristic exhibited by the I-channel signal in the optical front end 112. The frequency characteristic HI(f) is given by, for example, the photo detector 241, the TIA 251, and electrical conductors in the optical front end 112. A frequency characteristic HQ(f) is a frequency characteristic exhibited by the Q-channel signal in the optical front end 112. The frequency characteristic HQ(f) is given by, for example, the photo detector 242, the TIA 252, and electrical conductors in the optical front end 112. The frequency characteristic HI(f) and the frequency characteristic HQ(f) have a difference due to variations in manufacturing of the optical front end 112.

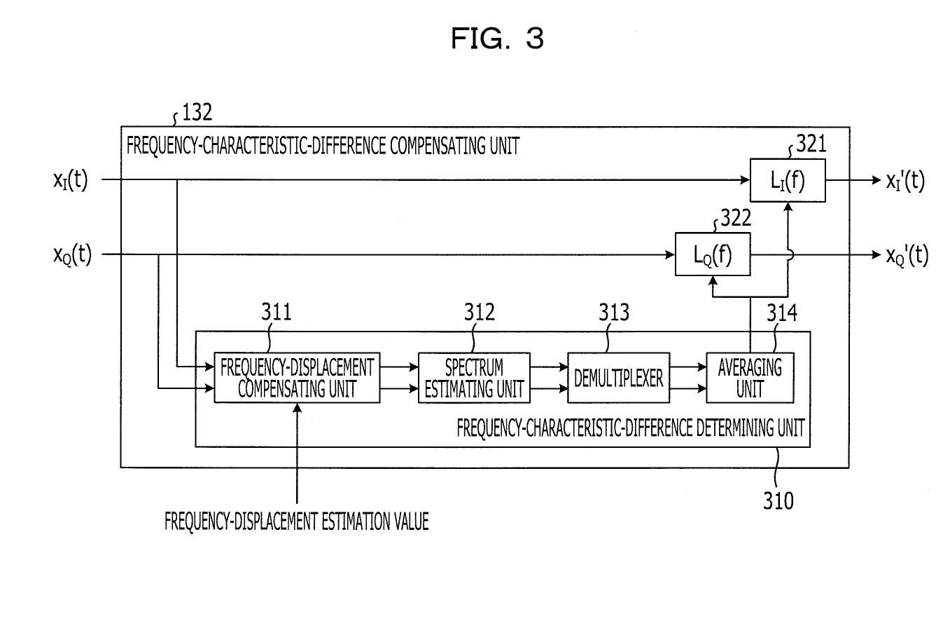

FIG. 3 is a block diagram illustrating a specific example of the frequency-characteristic-difference compensating unit illustrated in FIG. 1. As illustrated in FIG. 3, the frequency-characteristic-difference compensating unit 132 includes a frequency-characteristic-difference determining unit 310 and filters 321 and 322. The I-channel signal XI(t) and the Q-channel signal XQ(t) output from the skew compensating unit 131 are input to the frequency-characteristic-difference compensating unit 132. The frequency-characteristic-difference determining unit 310 includes a frequency-displacement compensating unit 311, a spectrum estimating unit 312, a demultiplexer 313, and an averaging unit 314.

On the basis of the frequency-displacement estimation value output from the frequency-displacement estimating/compensating unit 143, the frequency-displacement compensating unit 311 compensates for a frequency displacement between the signal XI(t) and the signal XQ(t) input to the frequency-characteristic-difference compensating unit 132. The frequency-displacement compensating unit 311 outputs the frequency-displacement-compensated signals XI(t) and XQ(t) to the spectrum estimating unit 312.

The spectrum estimating unit 312 estimates spectra of the signals XI(t) and XQ(t) output from the frequency-displacement compensating unit 311. The spectrum estimating unit 312 outputs the estimated spectra to the demultiplexer 313. The demultiplexer 313 determines rates of the individual channels on the basis of the spectra output from the spectrum estimating unit 312. The demultiplexer 313 outputs the determined rates to the averaging unit 314.

The averaging unit 314 averages the rates output from the demultiplexer 313. Consequently, a frequency-characteristic difference between the channel signals can be determined. The averaging unit 314 outputs the determined frequency-characteristic difference to the filters 321 and 322.

The filter 321 corrects the I-channel signal XI(t), input to the frequency-characteristic-difference compensating unit 132, by using a filter coefficient LI(f) and outputs the corrected I-channel signal to the fixed equalizer 141. The filter 321 determines the filter coefficient LI(f) on the basis of the frequency-characteristic difference output from the averaging unit 314. The filter 322 corrects the Q-channel signal XQ(t), input to the frequency-characteristic-difference compensating unit 132, by using a filter coefficient LQ(f) and outputs the corrected Q-channel signal to the fixed equalizer 141. The filter 322 determines the filter coefficient LQ(f) on the basis of the frequency-characteristic difference output from the averaging unit 314.

The signal light input to the optical front end 112 is indicated by x(t), an I-channel component included in the signal light x(t) is indicated as signal light xI(t), and a Q-channel component included in the signal light x(t) is indicated as signal light jxQ(t). In this case, the signal light x(t) can be given by equation (1) below.

x(t)=x₁(t)+jx_{Q}(t) (1)

The signal output from the optical front end 112 is indicated by x′(t), an I-channel component included in the signal x′(t) is indicated as a signal x′I(t), and a Q-channel component included in the signal x(t) is indicated as a signal jx′Q(t). In this case, the signal x′(t) can be given by, for example, equation (2) below.

x′(t)=x′₁(t)+jx′_{Q}(t) (2)

A signal F(x(t)) obtained by performing Fourier transform on the signal light x(t) can be given by, for example, equation (3) below. A signal F(x(t)) obtained by performing Fourier transform on a conjugate complex signal x(t) of the signal light x(t) can be given by, for example, equation (4) below.

F(x(t))=x(f)=(f)=x₁(f)+jx_{Q}(f) (3)

F(x*(t))=x*(f)=x₁(f)+jx_{Q}(f) (4)

From equations (3) and (4), XI(f) can be given by equation (5) below and XQ(f) can be given by equation (6) below.

$$\begin{matrix}{x}_{1} ( f ) = \frac{x ( f ) + {x}^{*} ( - f )}{2} & ( 5 ) \\ {x}_{Q} ( f ) = \frac{x ( f ) - {x}^{*} ( - f )}{2 j} & ( 6 )\end{matrix}$$

From equations (5) and (6), a signal F(x′(t)) obtained by performing Fourier transform on the signal x′(t) can be given by, for example, equation (7) below.

$$\begin{matrix}F ( {x}^{′} ( t ) ) = {x}^{′} ( f ) \\ = {H}_{I} ( f ) {X}_{I} ( f ) + {jH}_{Q} ( f ) {x}_{Q} ( f ) \\ = \frac{{H}_{I} ( f ) + {H}_{Q} ( f )}{2} x ( f ) + \frac{{H}_{I} ( f ) - {H}_{Q} ( f )}{2} {x}^{*} ( - f )\end{matrix} \qquad ( 7 )$$

The first term in equation (7) represents signal components of the channel signals output from the optical front end 112. The second term in equation (7) represents noise components of the signals output from the optical front end 112, the noise components resulting from a frequency-characteristic difference (HI(f)−HQ(f)). Thus, compensation for the frequency-characteristic difference between the signals satisfies HI(f)=HQ(f), thus making it possible to eliminate the noise components.

The I-channel signal output from the optical front end 112 is a signal obtained by giving the frequency characteristic HI(f) to the I-channel signal XI(f) input to the optical front end 112, and can thus be expressed as HI(f)XI(f). The Q-channel signal output from the optical front end 112 is a signal obtained by giving the frequency characteristic HQ(f) to the Q-channel signal XQ(f) input to the optical front end 112, and can thus be expressed as HQ(f)XQ(f).

The spectrum estimating unit 312 estimates the signal HI(f)XI(f) and the signal HQ(f)XQ(f). The demultiplexer 313 determines rates of the signal HI(f)XI(f) and the signal HQ(f)XQ(f) estimated by the spectrum estimating unit 312. The averaging unit 314 determines an average value of the rates determined by the demultiplexer 313. Thus, a frequency-characteristic difference A(f) determined by the averaging unit 314 can be given by equation (8) below.

$$A ( f ) ≡ average \{ \frac{{H}_{Q} ( f ) {x}_{Q} ( f )}{{H}_{I} ( f ) {x}_{1} ( f )} \} = \frac{{H}_{Q} ( f )}{{H}_{I} ( f )} \qquad ( 8 )$$

On the basis of the frequency-characteristic difference A(f) determined by the averaging unit 314, the filter 321 corrects the I-channel signal XI(t) by using the filter coefficient LI(f) given by, for example, equation (9) below. On the basis of the frequency-characteristic difference A(f) determined by the averaging unit 314, the filter 322 corrects the Q-channel signal XQ(t) by using the filter coefficient LQ(f) given by, for example, equation (10) below.

$$\begin{matrix}{L}_{I} ( f ) ≡ \frac{1 + A ( f )}{2} & ( 9 ) \\ {L}_{Q} ( f ) ≡ \frac{1 + \frac{1}{A ( f )}}{2} & ( 10 )\end{matrix}$$

Therefore, a signal F(x″(t)) obtained by performing Fourier transform on a signal x″(t) output from the frequency-characteristic-difference compensating unit 132 can be given by, for example, equation (11) below.

$$\begin{matrix}F ( {x}^{″} ( t ) ) = {x}^{″} ( f ) \\ = {L}_{I} ( f ) {H}_{I} ( f ) {X}_{I} ( f ) + {jL}_{Q} ( f ) {H}_{Q} ( f ) {x}_{Q} ( f ) \\ = \frac{{H}_{I} ( f ) + {H}_{Q} ( f )}{2} x ( f )\end{matrix} \qquad ( 11 )$$

Comparison between equation (7) and equation (11) indicates that the noise components due to the frequency-characteristic difference (HI(f)−HQ(f)) between the signals are eliminated by the frequency-characteristic-difference compensating unit 132. Thus, setting the filter coefficients for the filters 321 and 322 on the basis of the frequency-characteristic difference A(f) determined by the frequency-characteristic-difference determining unit 310 makes it possible to eliminate the noise components due to the frequency-characteristic difference between the channels.

Variations in the frequency-characteristic difference produced by the optical front end 112 are slow relative to the signals passing through the filters 321 and 322. Thus, the frequency-characteristic-difference determining unit 310 may operate so that it does not completely follow the signals passing through the filters 321 and 322.

FIG. 4 is a block diagram illustrating a modification of the optical receiver illustrated in FIG. 1. In FIG. 4, elements having substantially the same configurations as those illustrated in FIG. 1 are denoted by the same reference numerals and descriptions thereof are not given hereinafter. As illustrated in FIG. 4, the frequency-displacement estimating/compensating unit 143 in the optical receiver 100 may output the frequency-displacement-compensated channel signals to the carrier-phase recovering unit 144 and the front-end error compensating unit 130.

In this case, it is not necessary for the frequency-displacement estimating/compensating unit 143 to output the frequency-displacement estimation value to the front-end error compensating unit 130. The frequency-characteristic-difference compensating unit 132 (see FIG. 5) compensates for the frequency-characteristic difference between the channel signals output from the skew compensating unit 131, on the basis of the channel signals output from the frequency-displacement estimating/compensating unit 143.

FIG. 5 is a block diagram illustrating the frequency-characteristic-difference compensating unit 132 illustrated in FIG. 4. In FIG. 5, elements having substantially the same configurations as those illustrated in FIG. 3 are denoted by the same reference numerals and descriptions thereof are not given hereinafter. The frequency-characteristic-difference compensating unit 132 illustrated in FIG. 4 may have a configuration in which the frequency-displacement compensating unit 311 (see FIG. 3) is eliminated, as illustrated in FIG. 5.

The channel signals output from the frequency-displacement estimating/compensating unit 143 are input to the spectrum estimating unit 312 in the frequency-characteristic-difference determining unit 310. The frequency displacement between the signals output from the frequency-displacement estimating/compensating unit 143 has been compensated for by the frequency-displacement estimating/compensating unit 143. Thus, with the configuration in which the frequency-displacement compensating unit 311 is eliminated, the frequency-characteristic-difference determining unit 310 can also accurately determine a frequency-characteristic difference between the channels.

Thus, by compensating for the frequency-characteristic difference between the channel signals, the optical receiver 100 according to an embodiment can eliminate noise due to the frequency-characteristic difference, thus making it possible to improve the accuracy of identification performed by the identifying unit 150. Thus, it is possible to accurately receive signals. Through the use of the channel signals whose frequency displacement between the signal light and the local light is compensated, the optical receiver 100 can accurately determine a frequency-characteristic difference between the channels to compensate for the frequency-characteristic difference. Thus, it is possible to more accurately receive signals.

The fixed equalizer 141 and the adaptive equalizer 142 (which serve as the dispersion compensating units) are disposed subsequent to the frequency-characteristic-difference compensating unit 132 to compensate for a dispersion of the signals whose frequency-characteristic difference is compensated for by the frequency-characteristic-difference compensating unit 132. This arrangement can reduce the amounts of penalty that occur in the fixed equalizer 141 and the adaptive equalizer 142. Thus, it is possible to more accurately receive signals.

The frequency-displacement estimating/compensating unit 143 is disposed subsequent to the fixed equalizer 141 and the adaptive equalizer 142 (the dispersion compensating units) to estimate a frequency displacement between the signals whose dispersion is compensated for by the fixed equalizer 141 and the adaptive equalizer 142. Thus, the frequency-displacement estimating/compensating unit 143 can accurately estimate a frequency displacement. It is, therefore, possible to accurately compensate for a frequency displacement between the channel signals, so that the frequency-characteristic-difference compensating unit 132 can accurately compensate for the frequency-characteristic difference between the channel signals. Thus, it is possible to more accurately receive signals.

According to the optical receiver 100, through use of the inter-channel frequency-displacement estimation value obtained by the frequency-displacement estimating/compensating unit 143 or the signals whose frequency displacement is compensated for by the frequency-displacement estimating/compensating unit 143, the optical receiver 100 can determine a frequency-characteristic difference and compensate for the frequency-characteristic difference. Thus, it is possible to improve the reception accuracy without significantly increasing the circuit scale.

Through compensation for the frequency-characteristic difference between the channel signals, the optical receiver 100 can improve the reception accuracy without use of a high-performance optical front end as the optical front end 112. Consequently, it is possible to suppress an increase in the cost of the optical receiver 100.

FIG. 6 is a block diagram of an optical receiver according to an embodiment. In FIG. 6, elements having substantially the same configurations as those illustrated in FIG. 1 or 3 are denoted by the same reference numerals and descriptions thereof are not given hereinafter. An optical receiver 100 according to an embodiment includes a signal-distortion equalizer 610, a group-velocity dispersion (GVD) estimating unit 620, a skew estimating unit 630, and a coefficient controller 640 instead of the skew compensating unit 131, the frequency-characteristic-difference compensating unit 132, and the fixed equalizer 141 illustrated in FIG. 1.

The signal-distortion equalizer 610 corrects the channel signals output from the ADC 120 by using a set filter coefficient. The filter coefficient for the signal-distortion equalizer 610 is controlled by the coefficient controller 640. The signal-distortion equalizer 610 outputs the corrected signals to the adaptive equalizer 142. The adaptive equalizer 142 compensates for a dispersion of channel signals output from the signal-distortion equalizer 610.

The GVD estimating unit 620 estimates a GVD (group-velocity dispersion) of the signal light received by the optical front end 112. The GVD estimating unit 620 outputs the estimated dispersion to the coefficient controller 640. The skew estimating unit 630 estimates a skew (a phase displacement) of the signal light received by the optical front end 112. The skew estimating unit 630 outputs the estimated skew to the coefficient controller 640. The averaging unit 314 in the frequency-characteristic-difference determining unit 310 outputs the determined frequency-characteristic difference to the coefficient controller 640.

The coefficient controller 640 sets, for the signal-distortion equalizer 610, the filter coefficient based on the frequency-characteristic difference output from the frequency-characteristic-difference determining unit 310, the dispersion output from the GVD estimating unit 620, and the skew output from the skew estimating unit 630. For example, the coefficient controller 640 determines the filter coefficient by combining an inverse characteristic of the frequency-characteristic difference, an inverse characteristic of the dispersion, and an inverse characteristic of the skew.

The coefficient controller 640 sets the determined filter coefficient for the signal-distortion equalizer 610. With this arrangement, the signal-distortion equalizer 610 can compensate for the frequency-characteristic difference, the dispersion, and the skew of the signals output from the ADC 120.

FIG. 7 is a block diagram illustrating a modification of the optical receiver illustrated in FIG. 6. In FIG. 7, elements having substantially the same configurations as those illustrated in FIG. 6 are denoted by the same reference numerals and descriptions thereof are not given hereinafter. As illustrated in FIG. 7, the frequency-displacement estimating/compensating unit 143 in the optical receiver 100 may output the frequency-displacement-compensated channel signals to the carrier-phase recovering unit 144 and the frequency-characteristic-difference determining unit 310.

In this case, it is not necessary for the frequency-displacement estimating/compensating unit 143 to output the frequency-displacement estimation value to the frequency-characteristic-difference determining unit 310. The frequency-characteristic-difference compensating unit 310 determines a frequency-characteristic difference between the channel signals, on the basis of the channel signals output from the frequency-displacement estimating/compensating unit 143. The frequency-characteristic-difference compensating unit 132 may have a configuration in which the frequency-displacement compensating unit 311 (see FIG. 6) is eliminated.

The channel signals output from the frequency-displacement estimating/compensating unit 143 are input to the spectrum estimating unit 312 in the frequency-characteristic-difference determining unit 310. The frequency displacement between the signals output from the frequency-displacement estimating/compensating unit 143 has been compensated for by the frequency-displacement estimating/compensating unit 143. Thus, with the configuration in which the frequency-displacement compensating unit 311 is eliminated, the frequency-characteristic-difference determining unit 310 can also accurately determine a frequency-characteristic difference between the channels.

Thus, in the optical receiver 100 according to an embodiment, the frequency-characteristic-difference compensating unit 132 and the fixed equalizer 141 (e.g., see FIG. 1) can be realized by the signal-distortion equalizer 610 and the coefficient controller 640. With this arrangement, it is possible to simplify the configuration of the optical receiver 100. The skew compensating unit 131 (e.g., see FIG. 1) can also be realized by the signal-distortion equalizer 610 and the coefficient controller 640. With this arrangement, it is possible to further simplify the configuration of the optical receiver 100.

FIG. 8A is a graph illustrating a signal output from the optical front end. A signal component 801 illustrated in FIG. 8A represents a signal component of the signal X″(f) output from the optical front end 112. A noise component 802 represents a noise component of the signal X″(f) output from the optical front end 112, the noise component resulting from the frequency-characteristic difference. Since the channel signals output from the optical front end 112 have a frequency-characteristic difference given by the optical front end 112, the amount of the noise component 802 is large.

FIG. 8B is a graph illustrating a signal output from the frequency-characteristic-difference compensating unit. A signal component 801 illustrated in FIG. 8B represents a signal component of the signal X″(f) output from the frequency-characteristic-difference compensating unit 132. A noise component 802 represents a noise component of the signal X″(f) output from the frequency-characteristic-difference compensating unit 132, the noise component resulting from the frequency-characteristic difference. The frequency characteristic difference of the signal X″(f) output from the frequency-characteristic-difference compensating unit 132, the frequency-characteristic difference being produced by the optical front end 112, is compensated for, and thus the amount of the noise component 802 is small as illustrated in FIG. 8B.

Thus, according to the embodiments described above, the frequency-characteristic-difference compensating unit 132 and the signal-distortion equalizer 610 compensate for the frequency-characteristic difference produced by the optical front end 112, thereby making it possible to reduce the amount of the noise component 802. Consequently, the identifying unit 150 can accurately identify signals, so that the signals can be received with high accuracy.

FIG. 9 is a block diagram of an optical receiver according to an embodiment. In FIG. 9, elements having substantially the same configurations as those illustrated in FIG. 6 are denoted by the same reference numerals and descriptions thereof are not given hereinafter. As illustrated in FIG. 9, an optical receiver 100 according to an embodiment includes a signal-quality monitor 910 instead of the frequency-characteristic-difference determining unit 310 illustrated in FIG. 6. The signal-quality monitor 910 monitors the qualities of the channel signals output from the carrier-phase recovering unit 144.

The signal-quality monitor 910 outputs the monitored signal qualities to the coefficient controller 640. The coefficient controller 640 controls the filter coefficient for the signal-distortion equalizer 610 so that the signal qualities output from the signal-quality monitor 910 are maximized. Consequently, for example, the skew, the frequency-characteristic difference, and the dispersion between the channel signals can be compensated for.

The coefficient controller 640 may also determine, as a reference filter characteristic, the filter coefficient obtained by combining an inverse characteristic of the dispersion output from the GVD estimating unit 620 and an inverse characteristic of the skew output from the skew estimating unit 630. Using the determined reference filter coefficient as a center value, the coefficient controller 640 controls the filter coefficient for the signal-distortion equalizer 610 so that the signal qualities output from the signal-quality monitor 910 are maximized. This arrangement makes it possible to efficiently search for an optimum filter coefficient for the signal-distortion equalizer 610.

For example, a golden section search method may be used as a method for searching for the optimum filter coefficient for the signal-distortion equalizer 610, the searching being performed by the coefficient controller 640. However, the method for searching for the optimum filter coefficient for the signal-distortion equalizer 610, the searching being performed by the coefficient controller 640, is not limited to the golden section search method and may be any other search algorithm.

As described above, through the use of the signals whose frequency displacement between the signal light and the local light is compensated, the optical receiver and the receiving method can accurately determine a frequency-characteristic difference between the channel signals to compensate for the frequency-characteristic difference. Thus, it is possible to accurately receive signals. The device and method selectively compensate for corresponding frequency-characteristic difference including by identifying each of the digital signals whose frequency-characteristic difference is reduced by the frequency-characteristic-difference reducing unit. A method of a receiver includes monitoring signals resulting from compensation for a frequency displacement between a signal light and a local light, and compensating for a frequency-characteristic difference between signals of individual channels through which the signals are transmitted in accordance with an estimation value of the frequency displacement resulting from the monitoring.

The disclosed optical receiver and receiving method offer an advantage in that signals can be received with high accuracy.

Accordingly, the disclosed optical receiver and receiving method are aimed to overcome the above-described and other existing problems and to receive signals with high accuracy.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention, the scope of which is defined in the claims and their equivalents.

What is claimed is:

1. An optical receiver, comprising:
an optical front-end that splits an input signal light into signal light components based on a local light and converts the split signal light components into electrical signals;
a digital converter that converts the electrical signals, converted by the optical front end, into digital signals;
a frequency-characteristic-difference reducing unit that reduces a frequency-characteristic difference between the digital signals converted by the digital converter; and
an identifying unit that identifies each of the digital signals whose frequency-characteristic difference is reduced by the frequency-characteristic-difference reducing unit.

2. The optical receiver according to claim 1, comprising:
a frequency-displacement reducing unit that reduces a frequency displacement between the signal light and the local light, with respect to the digital signals converted by the digital converter; and
a determining unit that determines the frequency-characteristic difference based on the digital signals whose frequency displacement is reduced by the frequency-displacement reducing unit, and
wherein the frequency-characteristic-difference reducing unit reduces the frequency-characteristic difference between the digital signals based on the frequency-characteristic difference determined by the determining unit.

3. The optical receiver according to claim 2, comprising:
a dispersion reducing unit that reduces a dispersion of the digital signals whose frequency-characteristic difference is reduced by the frequency-characteristic-difference reducing unit, and
wherein the frequency-displacement reducing unit estimates the frequency displacement between the digital signals whose dispersion is reduced by the dispersion reducing unit and reduces the frequency displacement.

4. The optical receiver according to claim 3, wherein the frequency-characteristic-difference reducing unit and the dispersion reducing unit are implemented by a filter and a controller that controls a filter coefficient for the filter.

5. The optical receiver according to claim 4, comprising:
a dispersion estimating unit that estimates a dispersion of the signal light, and
wherein the controller controls the filter coefficient based on the frequency-characteristic difference determined by the determining unit and the dispersion estimated by the dispersion estimating unit.

6. The optical receiver according to claim 5, comprising:
a skew estimating unit that estimates a skew of the signal light, and
wherein the controller controls the filter coefficient based on the frequency-characteristic difference, the dispersion, and the skew estimated by the skew estimating unit.

7. A receiving method, comprising:
splitting an input signal light into signal light components based on a local light;
converting the split signal light components into electrical signals;
converting the electrical signals into digital signals;
reducing a frequency-characteristic difference between the digital signals; and
identifying each of the digital signals whose frequency-characteristic difference is reduced.

8. A method of an optical receiver, comprising:
monitoring signals resulting from compensation for a frequency displacement between a signal light and a local light; and
compensating for a frequency-characteristic difference between signals of individual channels through which said signals are transmitted in accordance with an estimation value of the frequency displacement resulting from said monitoring.
